(19) United States
(12) Patent Application Publication
(10) Pub. No.: US 2003/0235399 A1
(43) Pub. Date: Dec. 25, 2003

(54) Imaging apparatus

(75) Inventor: Norihiro Kawahara, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/452,446

(22) Filed: Jun. 3, 2003

(30) Foreign Application Priority Data
Jun. 24, 2002 (JP) 182360/2002

(51) Int. Cl. H04N 5/76; H04N 5/225; H04N 5/91; H04N 7/00

(52) U.S. Cl. 386/46; 386/117

(57) ABSTRACT

An apparatus inputs guide information including a plurality of representative image data indicating a representative image relating to a predetermined region, representative location information corresponding to the plurality of representative image data, and character information indicating a legend concerning the predetermined region displays the plurality of representative images and the legend in a predetermined layout on the basis of this guide information, and retrieves image data relating to the representative image from a plurality of image data photographed and recorded on a recording medium, on the basis of the representative location information corresponding to a representative image selected among the displayed plurality of representative images.

### BACKGROUND OF THE INVENTION

1. Field of the Invention

The present invention relates to an imaging apparatus, and in particular to an apparatus for recording information of a photographing position together with image data, at the time of photographing.

2. Related Background Art

In a conventional image recording and reproducing apparatus, as described in Japanese Patent Application Laid-open No. 7-320457, in order to reproduce an image recorded in advance and an image recorded later in association with each other, association information is prepared to link the images with each other at the time of recording.

However, in the conventional example, in associating an existing image and an image recorded anew, a user adds association information manually while looking at the images. Thus, considerable time and labor are required for realizing simple image retrieval using a link function.

### SUMMARY OF THE INVENTION

It is an object of the present invention to solve the problem as described above.

It is another object of the present invention to make it possible to easily retrieve a desired image out of a large number of images.

In order to solve the above-mentioned problem and attain the above-mentioned objects, the present invention presents, as an aspect thereof, an imaging apparatus including: image pickup means; location detection means for detecting a present location and outputs photographing position information; recording means for recording image data obtained by the image pickup means and the photographing position information outputted from the location detection means in association with each other on a recording medium; and retrieval means for, based upon representative location information corresponding to representative image data and photographing position information corresponding to a plurality of image data recorded on the recording medium, retrieving image data relating to the representative image data among the plurality of image data recorded on the recording medium.

Other objects and features of the present invention will be apparent from the following detailed description of embodiments of the present invention taken in conjunction with the accompanying drawings.

### BRIEF DESCRIPTION OF THE DRAWINGS

In the accompanying drawings:

FIG. 1 is a diagram showing a video camera;

FIG. 2 is a diagram showing a format of a photographed image data;

FIG. 3 is a diagram showing a format of guide page data;

FIG. 4 illustrates a display example of a guide page;

FIG. 5 is a flowchart showing operations of a first embodiment;

FIG. 6 is a flowchart showing retrieval processing of a photographing range;

FIG. 7 illustrates a relation between a map and location information;

FIG. 8 is a flowchart showing other retrieval processing of the first embodiment;

FIG. 9 illustrates-a relation between a map and location information;

FIG. 10 is a flowchart showing retrieval operations of a second embodiment;

FIG. 11 illustrates a relation among, a map, location information, and direction information;

FIG. 12 is a flowchart showing operations for landmark retrieval;

FIG. 13 is a flowchart showing operations for self-formation of a guide page; and

FIG. 14 is a diagram showing a video camera of a fifth embodiment.

### DETAILED DESCRIPTION OF THE PREFERRED EMBODIMENTS

Embodiments of the present invention will be hereinafter described in detail with reference to the accompanying drawings.

First Embodiment

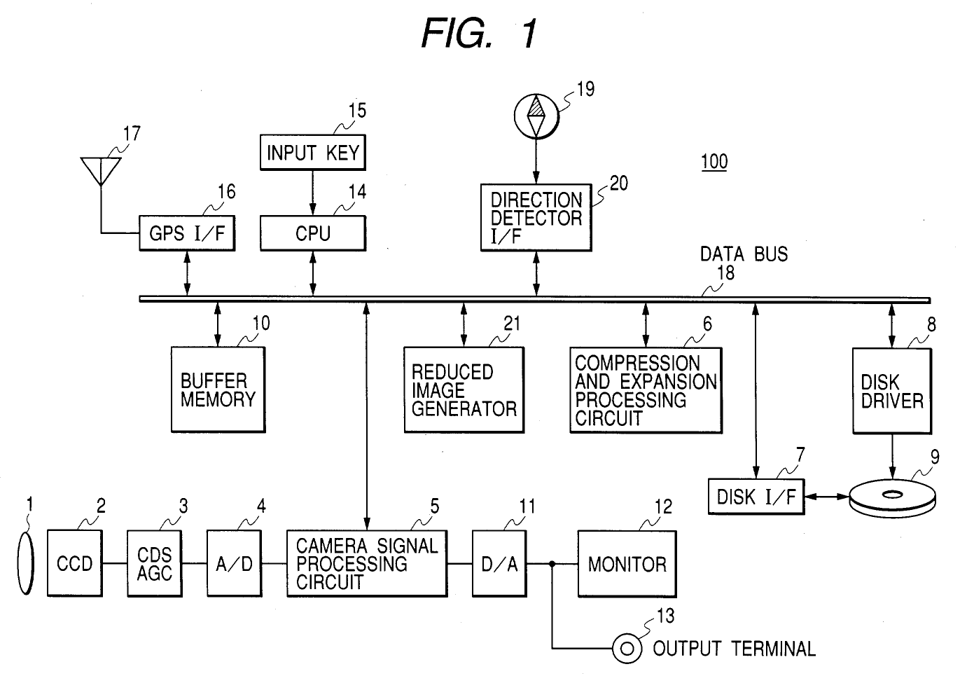

FIG. 1 is a block diagram showing a structure of a recording and reproducing apparatus to which the present invention is applied. The recording and reproducing apparatus of FIG. 1 is a video camera having a function for recording a signal from an image pickup element such as a CCD on a disk medium.

In FIG. 1, a signal, which has passed through a lens 1 and has undergone photoelectrical conversion in a CCD 2, is subjected to processing such as noise removal and gain adjustment in a pre-processing circuit 3 and is A/D converted in an AD converter 4. Moreover, the signal is subjected to signal processing of an image pickup system such as aperture correction, gamma correction, and white balance in a camera signal processing circuit 5. An output signal of the camera signal processing circuit 5 is converted into an analog signal in a D/A converter 11 to display an image being photographed on an attached monitor 12. Simultaneously, an output of the D/A converter 11 can also be sent to an output terminal 13 to display the image on an external device.

In recording the image photoelectrically converted in the CCD 2, the signal from the camera signal processing circuit 5 is once written in a buffer memory 10 through a data bus 18 and, subsequently, read out sequentially, and sent to a compression and expansion processing circuit 6 through the data bus 18 to have an information amount thereof compressed. The compressed image data is sent to a disk interface (I/F) 7 and is recorded on a disk 9 through the disk I/F 7. A disk driver 8 controls a rotational operation of a disk motor.

In addition, an antenna 17 picks up a radio wave from a satellite (not shown) to receive location information such as latitude and longitude. The Global Positioning System (GPS) interface 16 converts the location information such as latitude and longitude received by the antenna 17 into a data format to be recorded on the disk 9 and sends the location information to the buffer memory 10 via the data bus 18. The disk I/F 7 reads out the location information written in the buffer memory 10 at predetermined timing and records the location information on the disk 9 by multiplexing it with the image data.

A direction detector 19 detects, with a direction compass needle, etc., in which direction a video camera 100 is photographing. A direction detector interface 20 converts obtained direction information into a data format to be recorded on the disk 9 and writes the information in the buffer memory 10. Thereafter, the disk I/F 7 reads out the direction information from the buffer memory 10 at predetermined timing and records the information on the disk 9 together with the image data.

In the case in which the data in the disk 9 is reproduced, the disk 9 is rotated by the disk driver 8 to reproduce the data from the disk 9 through the disk I/F 7. The disk I/F 7 sends the reproduced data to the compression and expansion processing circuit 6 via the data bus 18 to expand the image data which was compressed at the time of recording in the compression and expansion processing circuit 6. The expanded image data is stored in the buffer memory 10 and, then, sent to the camera signal processing circuit 5 via the data bus 18 and is subjected to blanking addition, color modulation, and the like, converted into an analog signal in the D/A converter 11, and sent to an output terminal 13, wile displaying a reproduced image on the attached monitor 12.

At this point, in the case in which a size of the reproduced image is reduced, the image data stored in the buffer memory 10 after being expanded is reduced in size in a reduced image generator 21 to generate a reduced image such as a thumbnail image and, then, written in the buffer memory 10 again. Processing for displaying the reduced image generated at this point on the attached monitor 12 and recording it on the disk 9 is the same as the above-mentioned operations at the time of usual recording and reproduction.

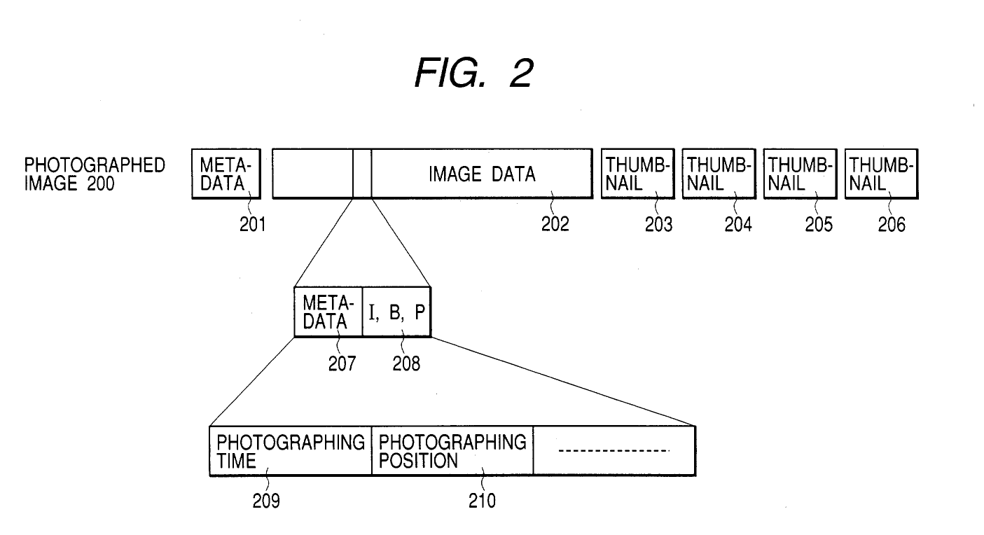

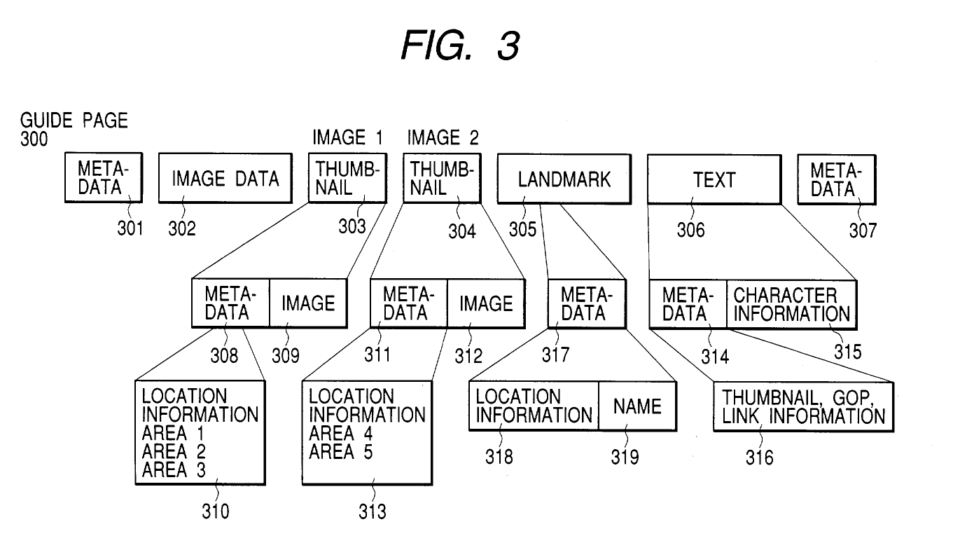

In this embodiment, guide page data shown in FIG. 3 is recorded on the disk 9 in advance, and a photographed image shown in FIG. 2 is recorded therein later.

FIG. 2 is a diagram showing a file structure of photographed image data 200 to be recorded on the disk 9.

The image data 200 consists of meta-data to be header, image data 202, a plurality of thumbnail image data 203 to 205, and meta-data 206 to be footer.

In this embodiment, image data is encoded by the MPEG system. In the MPEG system, the image data is encoded with a GOP basis, which GOP consists of a predetermined number of frames including an intra-frame encoded frame and a plurality of inter-frame encoded frames. Each GOP consists of a meta-data 207 and an image data part 208. The image data part 208 consists of three types of encoding frames: an I frame which does not need a reference image other than itself; a P frame predicted in the forward direction from a preceding I or P frame; and a B frame predicted bi-directionally from I preceding and succeeding or P frames. Photographing time information 209, the above-mentioned photographing position information 210, and the like are stored in the meta-data 207.

Although the number of the thumbnail image data 203 to 205 is equivalent to three frames for each file in FIG. 2, it is not limited to this. In addition, each of the thumbnail image data 203 to 205 is representative image data representing one frame of the image data 202.

FIG. 3 is a diagram showing a file structure of a guide page 300 recorded on the disk 9.

The guide page 300 consists of image data 302, a plurality of thumbnail image data 303 and 304, landmark data 305 in which sightseeing spots of various places, which can be a photographing object, are registered, a text 306 in which a legend concerning an image is written, and meta-data 307 to be footer.

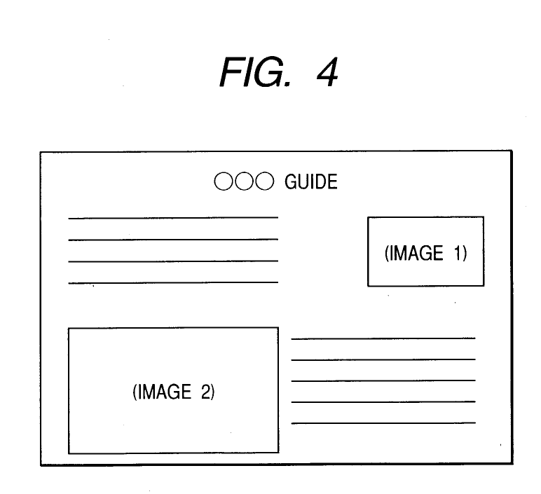

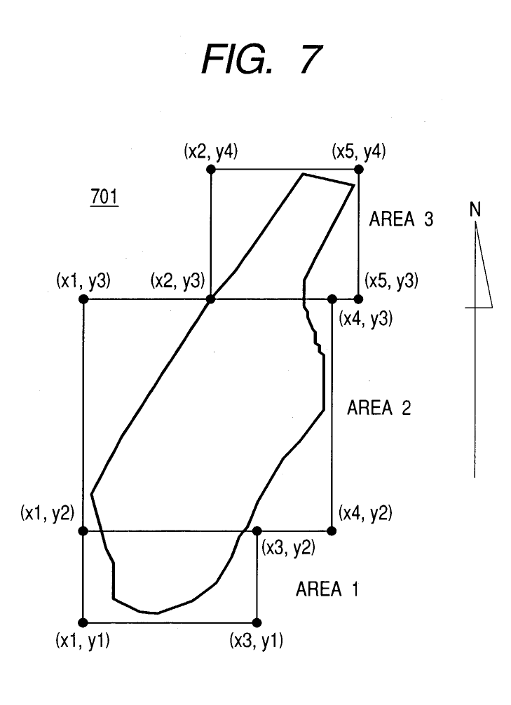

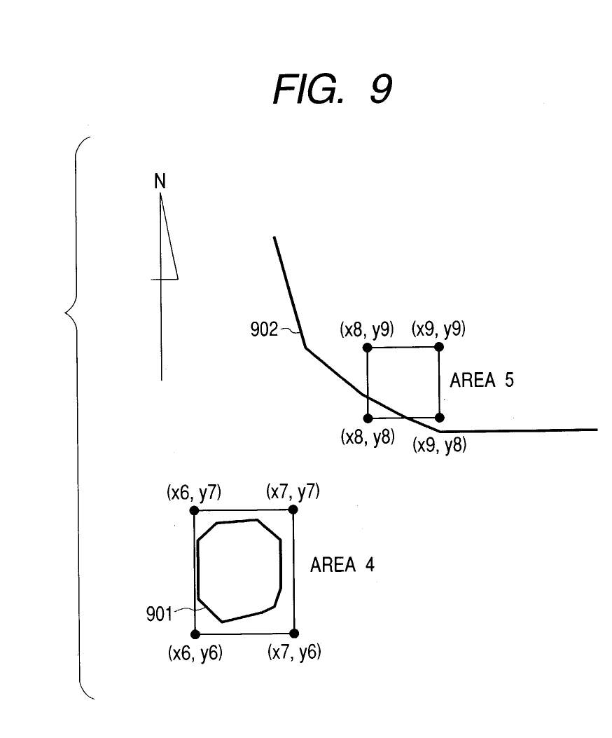

It is assumed that the thumbnail 303 indicates an image 1 of a guide page shown in FIG. 4 and the thumbnail 304 indicates an image 2 of FIG. 4. Coordinates 310 at total eleven points representing areas 1 to 3 shown in FIG. 7 are stored in meta-data 308 of the thumbnail 303. Image data 309 is recorded in association with the meta-data 308. Coordinates 313 at four points representing an area 4 and four points representing an area 5 shown in FIG. 9 are stored in meta-data 311 of the thumbnail 304. An image 312 is recorded in association with the meta-data 311.

The landmark data 305 includes a plurality meta-data 317, and each meta-data 317 consists of location information 318 representing a location of a landmark and name information 319 representing a name of the landmark. Link information 316 concerning the image 1 and the image 2 of FIG. 4 is stored in meta-data 314 of the text 306, and the link information 316 specifies which image is to be displayed on which page on the text 306. A text to be actually displayed is written in character information 315. Although three thumbnail images are shown as an example in this embodiment, the number of thumbnail images is not limited to this. In addition, if an image in the image data 302 is designated as a link destination in the link information 316, it is also possible to display a moving image on the image of FIG. 4. Further, the guide page is not limited to one page as shown in FIG. 4 but may extend across a plurality of pages.

FIG. 4 illustrates a display example of the guide page 300. Here, the image 1 and the image 2 are displayed together with the legend. For example, in the case of a guide of New York, buildings in Manhattan are shown on the image 1 and the Statue of Liberty photographed from the Battery Park is shown on the image 2, and the image 1 and the image 2 form guide images in conjunction with legends for them.

FIG. 7 shows a relation between a map and location information in the case in which the image 1 of FIG. 4 represents the buildings in Manhattan. In this embodiment, as location information representing locations in the entire Manhattan Island, the Manhattan Island 701 shown in FIG. 7 is divided into, for example, areas 1 to 3, and four corners of the areas 1 to 3 are represented by illustrated coordinates, respectively, assuming that the top of FIG. 7 is the due north. If it is desired to represent the entire Manhattan Island more accurately, the respective areas only has to be divided into smaller areas.

As means for obtaining the guide page described above, a disk having the guide page recorded therein may be sold as a “travel guide disk”, or a guide page file stored in an external server may be downloaded using communication means such as the Internet.

In this embodiment, the video camera has a function of retrieving and reproducing the image data recorded on the disk 9 using the guide image shown in FIG. 4.

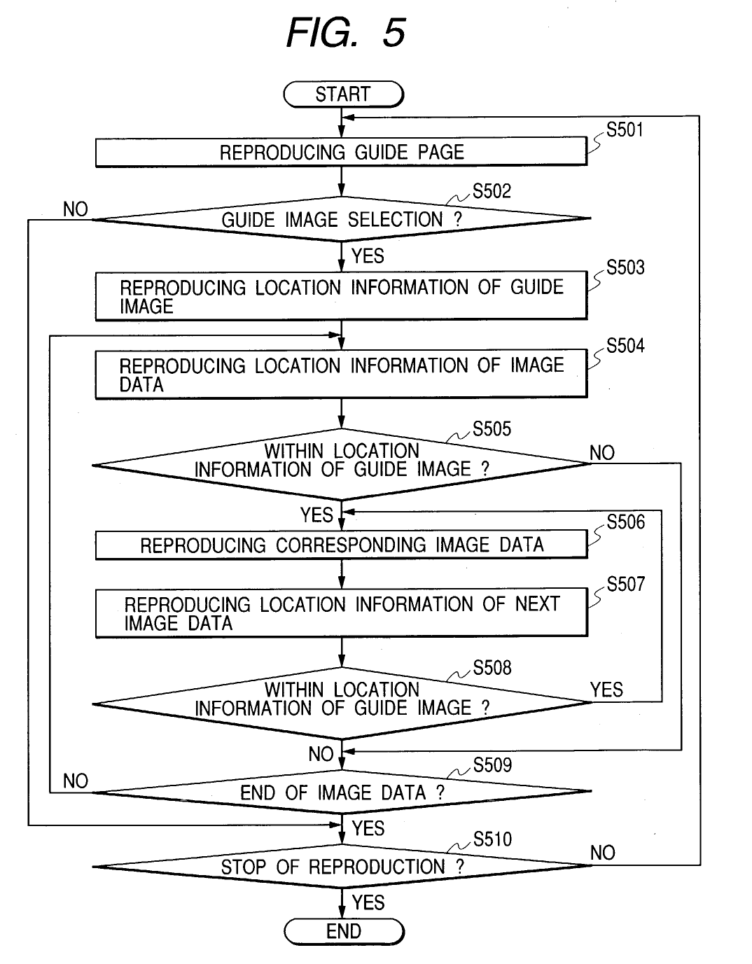

Next, processing in selecting an image in the guide image of FIG. 4 and reproducing the image will be described using a flowchart of FIG. 5. FIG. 5 is a flowchart showing operations of a CPU 14 in retrieval processing using a guide image. Further, in the processing of FIG. 5, the CPU 14 sequentially reproduces a large number of photographed image data recorded on the disk 9, selects only a part of the. data relating to a designated image in a guide page, and reproduces the part.

First, when a user instructs reproduction of a guide page with an input key 15, the CPU 14 reproduces data of the guide page recorded on the disk 9. Then, the CPU 14 creates a guide page image shown in FIG. 4 based upon contents of information on this guide page and displays the guide page image on the monitor 12 (step S501). Subsequently, the CPU 14 waits for the image 1 or the image 2 to be selected by the input key 15 (step S502). When, for example, the image 1 is selected, the CPU 14 reads out location information 310 of the thumbnail 303 of FIG. 3 and calculates an area indicated by the image 1 (step S503).

Next, the CPU 14 reads out the photographing position information 210 added to each GOP in the image data 202 in the photographed image data 200 of FIG. 2 recorded on the disk 9 (step S504), and compares the location information 210 and the location information (area information) 310 of FIG. 3 (step S505). If the location information 210 does not belong to any of the areas 1 to 3 of FIG. 7 designated by the location information 310, the CPU 14 proceeds to step S509 and judges whether or not the retrieval processing of location information has been completed for all the image data. If the location information 210 is included in any of the areas 1 to 3 of FIG. 7 designated by the location information 310, the CPU 14 reproduces image data of a corresponding GOP (step S506).

While the image data is being reproduced, the CPU 14 reproduces location information of each GOP sequentially (step S507) and compares the reproduced location information with the location information 310 of FIG. 3 (step S508). In this way, while the location information of the photographed image data 200 is included in any of the areas 1 to 3 of FIG. 7 designated by the location information 310, the CPU 14 reproduces the image data according to the processing of steps S7 to S9.

In case that the location information 210 of the photographed image data 200 is not included in any of the areas 1 to 3 designated by the location information 310, the CPU 14 judges whether or not the retrieval processing of location information has been finished for all the image data recorded in the disk 9 (Step S509). If the retrieval processing has not been finished for all the image data, the CPU 14 returns to step S504. When the processing for all the image data has been finished, the CPU 14 judges whether or not the user has instructed to stop the reproduction (step S510). If instruction to stop the reproduction has not been given, the CPU 14 returns to step S501 to reproduce the guide page 300 and comes into a state of waiting for selection of a guide image.

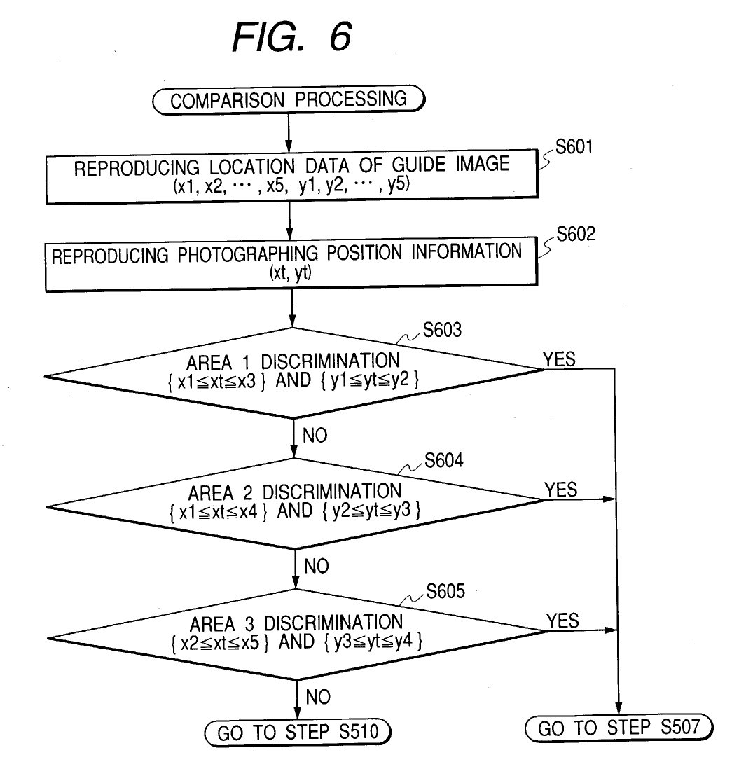

Next, comparison processing of steps S505 and S508 in FIG. 5 will be described using a flowchart of FIG. 6.

For example, if the image 1 of FIG. 4 is selected, since the respective coordinate points of FIG. 7 are recorded in the location information 310 of FIG. 3, the CPU 14 reads them out (step S601). Next, the CPU 14 determines coordinates xt and yt of the location information 210 reproduced from the disk 9 (step S602), compares the location information of the guide page and the location information of the photographed image to determine first whether or not the location information xt and yt of the photographed image are included in an area 1 of FIG. 7 (step S603). If the location information 210 is included in the area 1, the CPU 14 proceeds to step S506 in order to start reproduction of a GOP corresponding to this location information.

If the location information 210 is not included in the area 1, next, the CPU 14 judges whether or not the location information 210 is included in the area 2 (step S604). If the location information 210 is included in the area 2, the CPU 14 proceeds to step S506. If the location information 210 is not included in the area 2, next, the CPU 14 judges whether or not the location information 210 is included in the area 3 (step S605). If the location information 210 is included in the area 3, the CPU 14 proceeds to step S506.

If the location information 210 is not included in the area 3 either, the CPU 14 proceeds to step S509 in order to execute processing for the next GOP.

Note that, in this embodiment, an area is divided in a lattice shape and location information is judged as included in the area if the location information satisfies conditions on both the x axis and the y axis. However, a method of judgment is not limited to this. An area may be divided into triangles to judge whether or not location information is included in the area according to whether or not it is included in an area surrounded by linear functions.

As described above, in this embodiment, location information is added to a guide image on a guide page, in which explanations of each sightseeing spot are written, to be recorded on a disk in advance, and location information added to an image at the time of photographing and the location information of a selected guide image are compared to automatically reproduce the image. Thus, a user is capable of easily retrieving and reproducing a desired photographed image only by a simple operation of selecting a guide image.

More specifically, when the user displays the guide page of FIG. 4 and selects the image 1 on which the Manhattan Island is shown, an image recorded in Manhattan is automatically retrieved from among the image data recorded on the disk 9, and reproduced. Thus, it is possible to instantaneously retrieve an image recorded in New York from a disk in which images obtained during travel all over the United States are recorded.

Note that, although photographing position information is added and recorded for each GOP of photographed image data in this embodiment, location information may be added for each photographed image file of FIG. 2. More specifically, the CPU 14 retrieves location information at the time when start of photographing is instructed and stores the location information in the buffer memory 10. Then, the CPU 14 stores photographing position information in the file header (meta-data) 201 of FIG. 2 in response to the end of photographing and records the location information on the disk 9.

In this embodiment, a series of moving images, which are recorded in a period from the instruction to start photographing until the instruction to end photographing, are recorded on the disk 9 as one file. Therefore, photographing position information is recorded for each file.

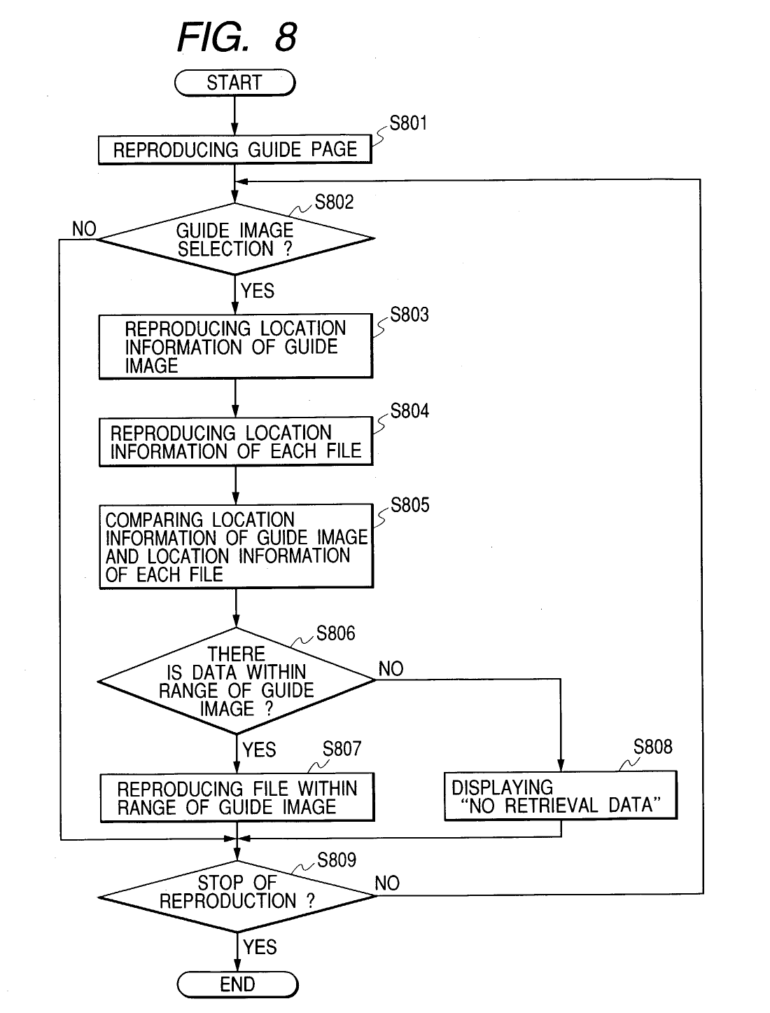

Further, retrieval processing using the photographing position information added for each file in this way will be described by referring to a flowchart of FIG. 8. FIG. 8 is a flowchart showing retrieval and reproduction processing performed by the CPU 14 using the photographing position information added for each file.

In FIG. 8, when instruction to reproduce a guide image is given, the CPU 14 reproduces the guide data of FIG. 3 from the disk 9 through the disk I/F 7 and writes the guide data in the buffer memory 10. Then, the CPU 14 creates the guide image shown in FIG. 4 and displays it on the monitor 12 (step S801). Next, the CPU 14 judges whether or not the guide image of FIG. 4 is selected (step S802) and, if either of the guide images 1 and 2 is selected, the CPU 14 reads out from the memory 10 the location information 310 or 313 of the selected image 1 or 2 from the guide page data 300 of FIG. 3 (step S803).

Next, the CPU 14 controls the disk I/F 7 to read out the header (meta-data) 201 of the plurality of file data 200 recorded on the disk 9, respectively, and write it in the buffer memory 10 (step S804), and compares the location information of the guide image and photographing position information of each file (step S805). As a result, the CPU 14 detects photographing position information, which is included in an area designated by the location information of the guide image, from among the photographing position information of each file, and judges whether or not there are files within a range of the location information of the guide image (step S806).

If there is data within the range, the CPU 14 controls the disk I/F 7 to sequentially reproduce the files within the range and display a reproduced image on the monitor 12 (step S807) On the other hand, if a file within the range of the guide image is not recorded at all, the CPU 14 displays information indicative of that effect on the monitor 12 and proceeds to step S809 (step S808).

When the reproduction of image files is finished in step S807, the CPU 14 judges whether or not the user has instructed to stop the reproduction. If instruction to stop the reproduction has not been given, the CPU 14 returns to step S802 and displays the guide screen of FIG. 4 on the monitor 12 to wait for selection of a guide image (step S809).

In this way, even in the case in which photographing position information is added and recorded for each file, it becomes possible to display a guide page at the time of reproduction, retrieves an image file using location information of a guide image selected out of the guide page and the photographing position information for each file, and automatically reproduce the image file.

Second Embodiment

Next, operations in the case in which there are a plurality of location data of a guide image will be described. This embodiment is different from the first embodiment in that location data, which represents a plurality of areas apart from each other, is added to a guide image on a guide page.

FIG. 9 shows a relation between a map and location information in the case in which the image 2 of FIG. 4 shows the Statue of Liberty photographed from the Battery Park at the opposite bank.

Reference numeral 901 denotes the Liberty Island where the Statue of Liberty is set. The Liberty Island 901 is represented by coordinates shown in an area 4 in FIG. 9. On the other hand, reference numeral 902 denotes a part of Manhattan. The Battery Park, where a pier for ferry to the Liberty Island 901 is located, is represented by coordinates of an area 5. As shown in FIG. 3, both the area 4 and the area 5 are recorded in the location information of the image 2.

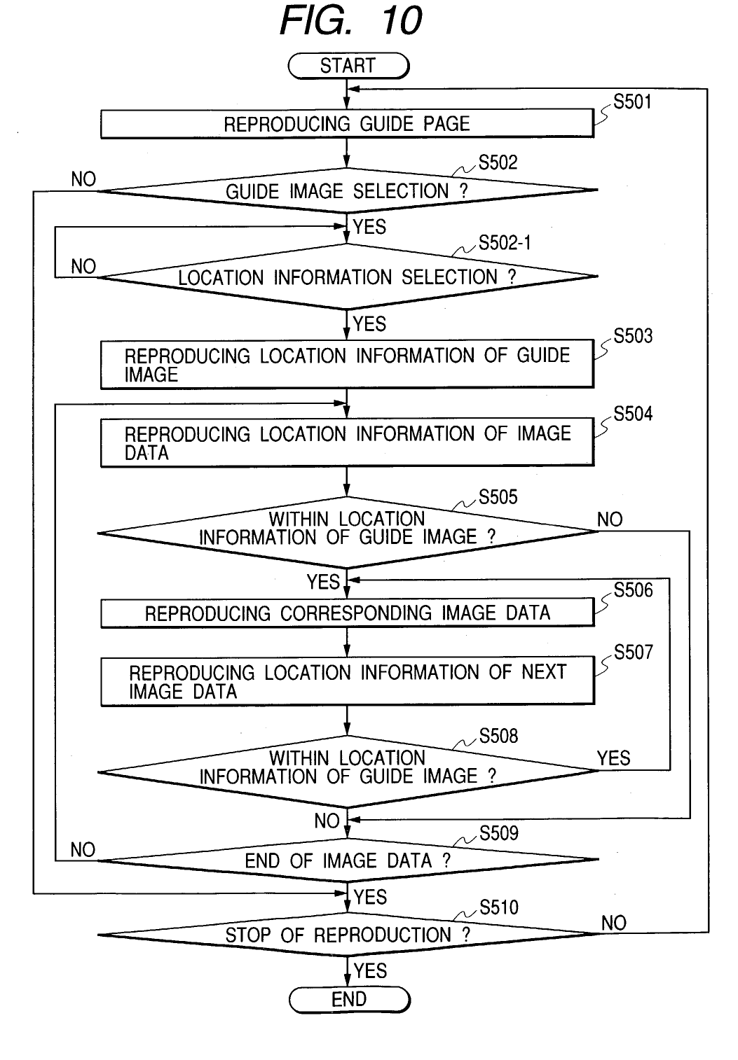

Operations for selecting an image, which has location information indicating a plurality of areas apart from each other, on the guide image of FIG. 4 to reproduce a recorded image will be described with reference to a flowchart shown in FIG. 10. Note that the same processing as in the flowchart of FIG. 5 is denoted by the identical reference symbol.

First, when a user instructs reproduction of a guide page with the input key 15, the CPU 14 reproduces data of the guide page recorded on the disk 9. Then, the CPU creates the guide page image shown in FIG. 4 based upon contents of this guide page information and displays it on the monitor 12 (step S501). Subsequently, the CPU 14 waits for the image 1 or the image 2 to be selected by the input key 15 (step S502). When, for example, the image 2 is selected, in order to urge the user to select the area 4 or the area 5 of FIG. 9, the CPU 14 displays information indicative of that effect on the monitor 12. When the area 4 or the area 5 is selected by the user (step S502-1), the CPU 14 reads out selected one of location information 313 recorded in the thumbnail 304 of FIG. 3 and calculates an area thereof (step S503).

Next, the CPU 14 reads out the photographing position information 210 added for each GOP in the image data 202 in the photographed image data 200 of FIG. 2 recorded on the disk 9 (step S504) and compares the location information 210 and the location information (area information) 310 of FIG. 3 (step S505). If the location information 210 belongs to neither the area 4 nor the area 5 of FIG. 9 designated by the location information 310, the CPU 14 proceeds to step S509 and judges whether or not the retrieval processing of location information has been finished for all the image data. If the location information 210 is included in the area selected in step S502-1 out of the areas 4 and 5 of FIG. 7 designated by the location information 310, the CPU 14 reproduces image data of a corresponding GOP (step S506).

While the image data is being reproduced, the CPU 14 reproduces sequentially location information of each GOP (step S507) and compares the reproduced location information with the location information 310 of FIG. 3 (step S508). In this way, while the location information of the photographed image data 200 is included in the selected area, the CPU 14 reproduces the image data according to the processing of steps S7 to S9.

If the location information 210 of the photographed image data 200 is included in neither the area 4 nor the area 5 designated by the location information 310, the CPU 14 judges whether or not the retrieval processing of location information has been finished for all the image data recorded in the disk 9 (Step S509). If the retrieval processing has not been finished for all the image data, the CPU 14 returns to step S504. When the processing for all the image data has been finished, the CPU 14 judges whether or not the user has instructed to stop the reproduction (step S510). If instruction to stop the reproduction has not been given, the CPU 14 returns to step S501 to reproduce the guide page 300 and comes into a state of waiting for selection of a guide image.

In this embodiment, by adding location information representing a plurality of areas apart from each other to a guide image on a guide page, the CPU 14 can reproduce image data linking the image data to both an image photographed in a location of an object of the guide image and an image photographed by a user of a video camera in a location where the guide image was actually photographed by a guide page creator.

As a specific example, in the case in which the user selects the image 2 of FIG. 4 and selects the “Liberty Island” of the area 4 as location information, the video camera can automatically retrieve an image photographed in the Liberty Island where the Statue of Liberty as an object is located and reproduce an image of the Statue of Liberty in a near range.

In addition, in the case in which the user selects the “Battery Park” of the area 5 as location information, the video camera can automatically retrieve an image photographed in the Battery Park where the guide image creator photographed the Statue of Liberty and reproduce the image. At this point, if the user of the video camera has photographed an image of the “Statue of Liberty” at the same angle of view as the guide image, the video camera can instantaneously reproduce the image.

Third Embodiment

Next, an embodiment in which, as location information of a photographed image, location information automatically selected from the location information of landmarks described on the guide page 300 is recorded rather than location information itself from the GPSI/F 16 will be described.

In this embodiment, location information of sightseeing spots are registered in advance in the guide page area 300 of FIG. 3. A video camera detects that a user is photographing the registered sightseeing spot using not only a photographing position but also a photographing direction, and records the location information of the registered sightseeing spot as location information of the photographed image of FIG. 2.

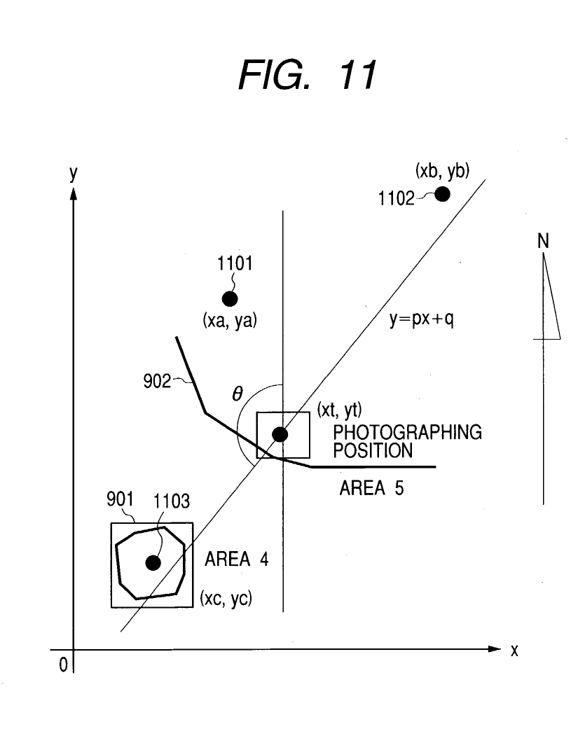

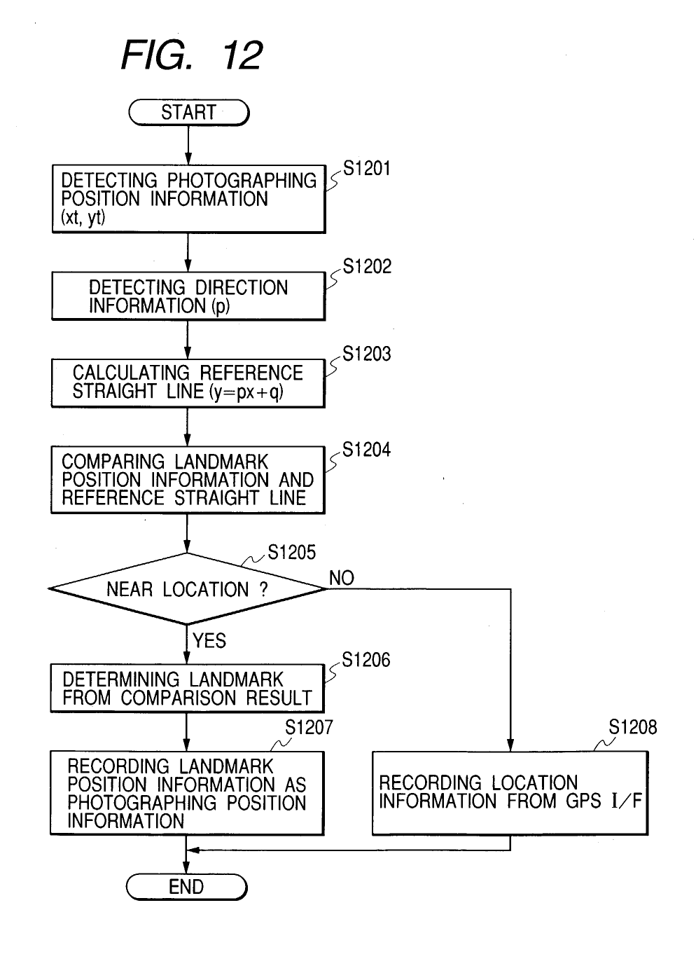

Operations for, when the area 4 (the Statue of Liberty) is photographed from the area 5 (the Battery Park) of FIG. 9, recording location information of the area 4 in the meta-data 207 of the photographed image shown in FIG. 2 will be described with reference to FIGS. 11 and 12.

“The Statue of Liberty” is registered in advance in the landmark information of the guide page data 300 as a landmark, and coordinates (xc, yc) are recorded in the location information 318 indicating the location of the Statue of Liberty, and the “Statue of Liberty” is recorded in the name information 319. In addition, it is assumed that landmarks 1101 (xa, ya) and 1102 (xb, yb) are registered in the landmark area 305 as other landmarks.

FIG. 12 is a flowchart showing detection and recording processing of location information performed by the CPU 14 at the time of moving image photographing by the video camera 100 of FIG. 1.

In FIG. 12, upon starting recording, the CPU 14 inputs photographing position information (xt, yt) shown in FIG. 11 through the GPSI/F 16 from the antenna 17 (step S1201). Next, the CPU 14 inputs photographing direction information 0 from the direction detector 19 through the direction detector I/F 20 (step S1202). Then, the CPU 14 uniquely calculates a straight line y=px+q shown in FIG. 11 based upon the photographing position information and the photographing direction information (step S1203).

Next, the CPU 14 sequentially reads out the landmark data 305 of the guide page data from the disk 9 through the disk I/F 7 and judges whether or not a location of each landmark is near the straight line y=px+q (step S1204).

For example, if the location information (xa, ya), (xb, yb), and (xc, yc) shown in FIG. 11 are registered in the landmark data 305, the CPU 14 excludes the location information (xa, ya) because it is not near the straight line y=px+q.

As a result of comparing location information and the straight line for all the landmarks, the CPU 14 judges whether or not there is a landmark in a near location (step S1205). Here, if a location of at least one land mark is near the straight line, the CPU 14 compares a value of the photographing position (xt, yt) and a value of the detected location information of the landmark to determine a final landmark to be a photographing object (step S1206).

For example, in the case of the example of FIG. 11, when a photographing direction is taken into account, both values of the coordinate components x and y of the landmark to be a photographing object are smaller than the value of the photographing position (xt, yt). Since a value of the location (xb, yb) of the landmark 1102 is larger than the value of the photographing position (xt, yt), it can be seen that the landmark 1102 is near the straight line y=px+q but is not a photographing object.

In addition, since a value of the location (xc, yc) of the landmark 1103 is smaller than the value of the photographing position (xt, yt), the CPU 14 determines that the photographing object is the landmark 1103.

When it is determined that the photographing object is the landmark 1103, the CPU 14 records location information of the landmark as the photographing position information 210 (step S1207). Note that, at this time, location information of a photographing point may be recorded together with location information of a landmark.

In addition, if it is judged that no landmark is near the straight line in step S1205, the CPU 14 records information of the photographing position inputted from the GPGI/F 16 as it is as the photographing position information 210 (step S1208).

In this way, in this embodiment, location data of sightseeing spots is registered as landmarks in advance and a photographing direction of a video camera is measured. Consequently, in the case in which a famous sightseeing spot is photographed from a place apart from a photographing object, location information of the photographing object can be recorded as photographing position information instead of a location of the video camera.

In the case of the example shown in FIG. 11, if the Statue of Liberty (area 4) is photographed from the Battery Park (area 5), the location information (xc, yc) of the “Statue of Liberty” can be recorded as photographing position information instead of the location information of the area 5 where the video camera exists.

The retrieval processing described with reference to FIGS. 5 and 8 in the first embodiment is performed using the photographing position information recorded as described above. Consequently, for example, if the Statue of Liberty photographed from the Battery Park of the image 2 is selected on the guide image of FIG. 4, an image of the Statue of Liberty photographed from a distant place can be immediately reproduced. That is, regardless of a photographing point, an object which is the same as a selected guide image can be instantaneously retrieved and reproduced.

Fourth Embodiment

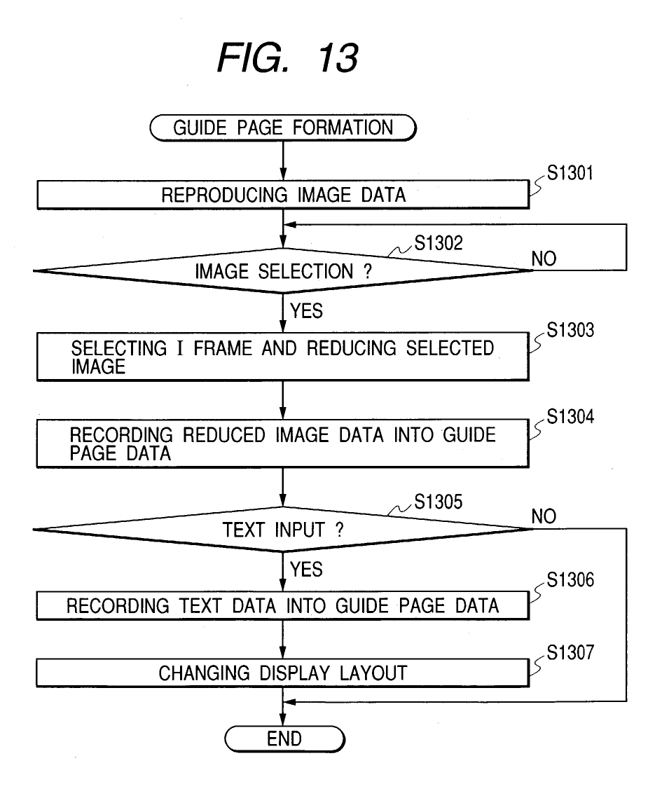

Next, an embodiment for automatically creating a guide page as shown in FIG. 4 using a photographed image will be described. FIG. 13 is a flowchart showing processing of the CPU 14 at the time when a guide page is created using the image data recorded in the disk 9 in the video camera 100 of FIG. 1.

When a user instructs creation (change) of a guide page with the input key 15, the CPU 14 controls the disk I/F 7 to reproduce moving image data from the disk 9 and displays a moving image on the monitor 21 (step S1301).

During reproduction of the moving image, the user pauses the reproduction at an image that the user wants to display as an image on the guide page of FIG. 4, and instructs the CPU 14 to generate a reduced image (step S1302). Then, the CPU 14 writes an I frame in a GOP including a frame which was being reproduced at the time when the pause was instructed, and the meta-data 207 of the GOP in the buffer memory 10 and, at the same time, reduces the size of image data of selected one frame with the reduced image generator 21 (step S1303). Then, the CPU 14 records the reduced image data in the thumbnail area of the guide page data 300 of the disk 9 together with the meta-data (step S1304).

In this case, when the user inputs a text (step S1305), the user inputs characters from the input key 15 to record the text in the character information 315 of a text area of the guide page data 300 (step S1306). Next, the user uses the input key 15 to change a display layout or the like of the reduced image (step S1307). After these operations, the CPU 14 ends the guide page formation.

In this way, a user generates a guide image from an image photographed by himself/herself, saves the guide image in a guide page together with location information thereof, and input a text to add a legend concerning the image. Consequently, even if the user cannot obtain a commercially available guide file or a guide file on a computer network, the user can form a guide page, and the simple retrieval of photographed image described in the first to third embodiments can be realized.

Fifth Embodiment

Next, processing in the case in which photographed image data and guide page data are recorded in different recording media will be described.

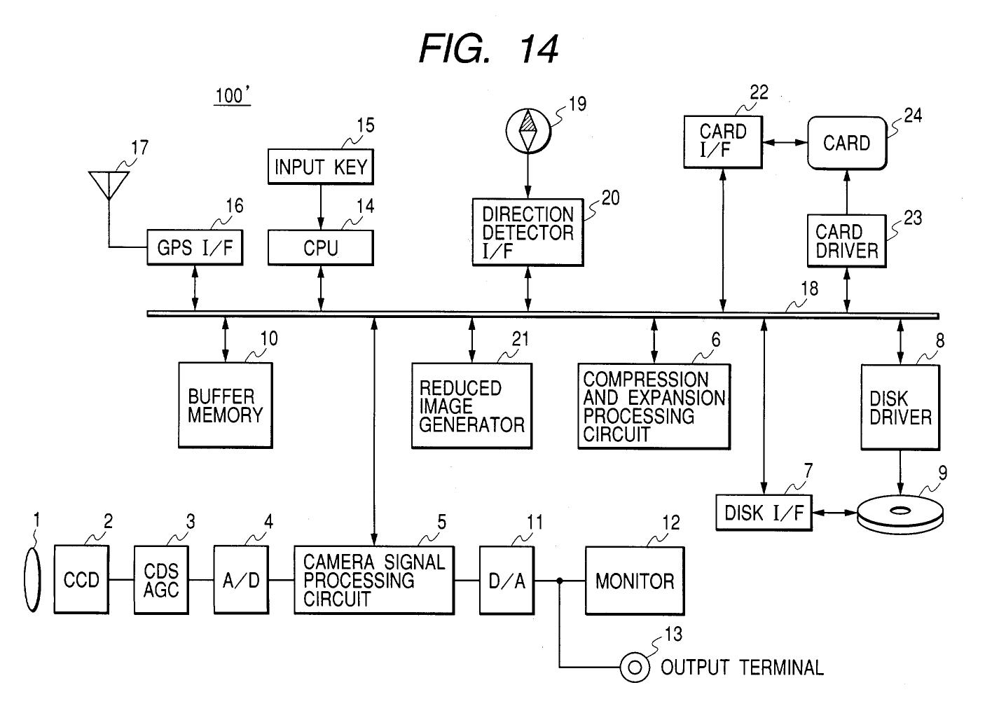

FIG. 14 is a diagram showing a structure of a video camera 100′ to which the present invention is applied.

In FIG. 14, components identical with those in the video camera 100 of FIG. 1 are denoted by the identical reference numerals and detailed description of the components will be omitted.

In FIG. 14, the guide page data 300 shown in FIG. 3 is recorded in a card 24 and, when the data is reproduced, clock is given to the card 24 by a card driver 23 to read out the data by a card I/F 22. The photographed image data is recorded on the disk 9 in the same manner as the above-mentioned embodiments.

In this embodiment, the video camera operates in the same manner as described in the first to fourth embodiments except that photographed image data and guide page data are recorded in different recording media.

Note that, contrary to the above description, a photographed image may be recorded in the card 24 and a guide page is recorded on the disk 9, or a disk, a disk driver and a disk interface circuit may be provided instead of the card 24, the card driver 23 and the card interface circuit 22 and a photographed image and a guide page may be recorded on different disks.

In this embodiment, a guide page and a photographed image are recorded on separate media, whereby the guide page and the photographed image can be clearly distinguished from each other.

When image data is recorded on a recording medium, positioning data from positioning means is simultaneously recorded. The recording medium has external image data and external location information, which is recorded together with external image data, in advance. When the external image data is selected, image data including positioning data coinciding with the external location information is reproduced, whereby retrieval of image data relating to the external image data can be realized easily.

In addition, when image data is recorded on a recording medium, positioning data from positioning means is simultaneously recorded. A Reference image is generated from the image data recorded on the recording medium. The positioning data is recorded on the recording medium as reference image location data, and an article concerning the reference image is inputted and recorded on the recording medium. When the reference image is selected, image data including positioning data coinciding with the reference image location data is reproduced, whereby a reference image for facilitating retrieval of the image data can be created from the image data.

In addition, a recording medium has landmark position information. When image data is recorded on the recording medium, one of landmark position information is selected out of landmark position information and recorded as pseudo positioning data together with the image data. The recording medium has external image data and external location information, which is recorded together with the external image data, in advance. When the external image data is selected, image data including pseudo positioning data coinciding with the external location information is reproduced, whereby retrieval of image data, in which the same object as that of the external image data is recorded, can be easily realized regardless of a photographing position.

In addition, when image data is recorded on a first recording medium, positioning data from positioning means is simultaneously recorded. A second recording medium has external image data and external location information which is recorded together with external image data. When the external image data is selected, image data including positioning data coinciding with the external location information is reproduced, whereby distinction between the image data and the external image data necessary for realizing easy retrieval can be clarified.

Further, reference image, existing location information representing a location where an object of the reference image exists, photographing position information representing a location where the subject was photographed, and an article concerning the subject are recorded on a recording medium, whereby a guidebook can be displayed on a video camera or the like, and easy retrieval of a photographed image can be realized.

Many widely different embodiments of the present invention may be constructed without departing from the spirit and scope of the present invention. It should be understood that the present invention is not limited to the specific embodiments described in the specification, except as defined in the appended claims.

What is claimed is:

1. An imaging apparatus comprising:
image pickup means;
location detection means for detecting a present location and outputs photographing position information;
recording means for recording image data obtained by the image pickup means and the photographing position information outputted from the location detection means in association with each other on a recording medium; and
retrieval means for, based upon representative location information corresponding to representative image data and photographing position information corresponding to a plurality of image data recorded on the recording medium, retrieving image data relating to the representative image data among the plurality of image data recorded on the recording medium.

2. An apparatus according to claim 1,
wherein the retrieval means performs retrieval processing using location information corresponding to representative image data selected among a plurality of representative image data.

3. An apparatus according to claim 1,
wherein the retrieval means perform the retrieval processing using location information selected among a plurality of pieces of location information corresponding to one of the representative image data.

4. An apparatus according to claim 2,
wherein the representative image data and the representative location information are recorded on the recording medium.

5. An apparatus according to claim 4,
wherein the representative image data and the representative location information are supplied from the outside of the apparatus to be recorded on the recording medium.

6. An apparatus according to claim 4,
wherein the recording means records image data of a-screen selected among a plurality of image data recorded on the recording medium as the representative image data on the recording medium and also records photographing position information of the image data of the selected screen as the representative location information on the recording medium.

7. An apparatus according to claim 4,
wherein the representative image data and the representative location information are recorded on the recording medium together with text information concerning the representative image data.

8. An apparatus according to claim 7, further comprising:
reproducing means for reproducing the representative image data, the representative location information, and the text information from the recording medium; and
display means for displaying a representative image, which relates to the representative image data, and the text information in a predetermined layout,
wherein the retrieval means performs the retrieval processing using location information of a representative image selected among the plurality of representative images displayed on the display means.

9. An apparatus according to claim 1,
wherein the representative image data and the representative location information are recorded on another recording medium different from the recording medium, and the retrieval means includes means for reproducing the representative image data and the location information from the other recording medium.

10. An apparatus according to claim 1,
wherein the representative image data indicates an image relating to a predetermined region and the representative location information indicates a location of the predetermined region.

11. An apparatus according to claim 1,
wherein the image data includes a moving image data and the recording means adds and records the photographing position information for every predetermined number of frames.

12. An apparatus according to claim 11,
wherein the recording means includes encoding means for encoding the moving image data, and adds the photographing position information for every predetermined encoding unit of encoding by the encoding means.

13. An apparatus according to claim 1,
wherein the recording means records a series of moving image data as one file on the recording medium and adds and records the photographing position information for each file.

14. An apparatus according to claim 1,
wherein the location detection means generates the photographing position information on the basis of landmark position information which corresponds to a predetermined landmark, and a present location of the apparatus.

15. An imaging apparatus comprising:
image pickup means;
location detecting means for detecting a present location and outputting photographing position information;
recording means for adding photographing position information outputted from the location detecting means to a series of moving image data obtained by the image pickup means to produce one file and recording the file on a recording medium; and
retrieval means for, based upon representative location information corresponding to representative image data and photographing position information of a plurality of files recorded in the recording medium, retrieving a file relating to the representative image data among a plurality of files recorded on the recording medium.

16. An apparatus according to claim 15, further comprising reproducing means for reproducing data of the file from the recording medium,
wherein the retrieval means controls the reproducing means so as to reproduce the retrieved file.

17. An image processing apparatus comprising:
inputting means for inputting guide information including a plurality of representative image data indicating a representative image relating to a predetermined region, representative location information corresponding to the plurality of representative image data, and character information indicating a legend concerning the predetermined region;
display means for displaying the plurality of representative images and the legend in a predetermined layout on the basis of the guide information; and
retrieval means for, based upon the representative location information corresponding to a representative image selected among a plurality of representative images displayed on the display means, retrieving image data relating to the representative image from a plurality of image data photographed by a photographing apparatus and recorded on a recording medium.

18. An apparatus according to claim 17, further comprising selection means for selecting an arbitrary image from the displayed plurality of representative images,
wherein the retrieval means retrieves image data relating to the selected representative image.

19. An apparatus according to claim 17,
wherein the retrieval means further performs the retrieval processing using representative location information selected among a plurality of pieces of representative location information concerning one representative image of the displayed plurality of representative images.

20. An apparatus according to claim 19, further comprising selection means for selecting an arbitrary representative location information from a plurality of pieces of representative location information concerning the one representative image,
wherein the retrieval means performs the retrieval processing using the selected representative location information.

21. An apparatus according to claim 17,
wherein the plurality of image data are recorded on the recording medium together with photographing position information indicating a photographing position of the plurality of image data, and the retrieval means performs the retrieval processing using representative location information which corresponds to the representative image, and the photographing position information.

22. An apparatus according to claim 17,
wherein the guide information is recorded on the recording medium, and the inputting means includes reproducing means for reproducing the guide information from the recording medium.

23. An imaging method comprising:
an image pickup step;
a location detection step of detecting a present location and outputting photographing position information;
a recording step of recording image data obtained in the image pickup step and the photographing position information outputted in the location detection step in association with each other in a recording medium; and
a retrieval step of, based upon representative location information corresponding to representative image data and photographing position information corresponding to a plurality of image data recorded on the recording medium, retrieving image data relating to the representative image data among the plurality of image data recorded on the recording medium.

24. An imaging method comprising:
an image pickup step;
a location detecting step of detecting a present location and outputting photographing position information;
a recording step of adding photographing position information outputted in the location detecting step to a series of moving image data obtained in the image pickup step to produce one file and recording the file on a recording medium; and
a retrieval step of, based upon representative location information corresponding to representative image data and photographing position information of a plurality of files recorded on the recording medium, retrieving a file relating to the representative image data among a plurality of files recorded on the recording medium.

25. An image processing method comprising:
an inputting step of inputting guide information including a plurality of representative image data indicating a representative image relating to a predetermined region, representative location information corresponding to the plurality of representative image data, and character information indicating a legend concerning the predetermined region;
a display step of displaying the plurality of representative images and the legend in a predetermined layout on the basis of the guide information; and
a retrieval step of, based upon the representative location information corresponding to a selected representative image among a plurality of representative images displayed in the display step, retrieving image data relating to the representative image from a plurality of image data photographed by a photographing apparatus and recorded on a recording medium.
